(19) United States
(12) Patent Application Publication
(10) Pub. No.: US 2002/0059443 A1
(43) Pub. Date: May 16, 2002

(54) 1394 module and data processing system with 1394 module

(76) Inventor: James Mu, Shindian City (TW)

Correspondence Address: RABIN & CHAMPAGNE, PC, 1101 14TH STREET, NW, SUITE 500, WASHINGTON, DC, 20005, US

(21) Appl. No.: 09/940,851

(22) Filed: Aug. 29, 2001

(30) Foreign Application Priority Data
Apr. 12, 2000 (TW) 90205721

(51) Int. Cl. G06F 15/16

(52) U.S. Cl. 709/232

(57) ABSTRACT

A 1394 module comprises a 1394 controller and a 1394 physical layer. The 1394 controller is connected to the system bus for transmitting bus signals. The 1394 physical layer is connected to an electronic device for transmitting differential signals. The 1394 controller and the 1394 physical layer have a two-way communication by a data signal and a control signal. In addition, a one-way communication by a link request signal, a link power status signal and a clock signal for accessing the internal register of the 1394 physical layer, assigning the power status of the 1394 controller, and synchronizing the request signal, the control signal, and the data signal.

This application incorporates by reference Taiwanese application Serial No. 90205721 Filed Apr. 12, 2001.

### BACKGROUND OF THE INVENTION

1. Field of the Invention

The invention relates in general to a digital data transmission device, and more particularly to a data transmission device compatible to the IEEE 1394 standard.

2. Description of the Related Art

The prosperity of the computer industry and the increasing popularity of the Internet have confirmed that the information technology plays an irreplaceable role in the modem society. One of the important functions of the information technology is communication. The communication comes from the ability to build a connection between the two units. For example, a connection may be built between a computer and its peripherals, or between a consumer electronic device and an information system. Transmission interfaces must be applied to the above system to ensure the quality of the data transmission between the two units. The conventional transmission interfaces are the RS-232 and the parallel interface. However, their drawbacks are low transmission rate and inconvenient connections. In order to fulfill the transmission requirement of nowadays technology, a Universal Serial Bus (USB) and an IEEE 1394 transmission interface have been developed as new standards. Since the USB and the IEEE 1394 transmission interface both have great merits of hot insertion/removal (or hot plug) and high transmission rate, the USB and the IEEE 1394 transmission interface will replace the conventional transmission interface and the market value of the USB or IEEE 1394 compatible will be enormous in the near future.

It is well known that the IEEE 1394 transmission interface can be connected to many different devices at the same time. For example, a single IEEE 1394 interface that applies today's technology can be connected to at least 63 devices. The IEEE 1394 interface can achieve a transmission rate up to 400 Mbit/sec, and it also supports the point-to-point data transmission. For example, the image data can be sent directly from the digital camera to the hard disk drive so it is not necessary to require the computer to deal with the data storage or the data transmittance anymore. Therefore, the point-to-point data transmission can save both time and resources. Since the IEEE 1394 interface provides the above advantages, it will become the data transmission standard for the next generation. This makes the companies in the industry eager to develop products compatible to the IEEE 1394 standard so that the companies can maintain their market share or increase their market competence.

### SUMMARY OF THE INVENTION

It is therefore an object of the invention to provide a 1394 module in order to improve the speed of the data transmission between the system bus and the electronic device.

The invention achieves the above-identified objects by providing a 1394 module. The 1394 module can be used as a data transmission media between the system bus and the electronic device. The 1394 module comprises a 1394 controller and a 1394 physical layer. The 1394 physical layer is connected to the system bus and is used for transmitting the differential signal. The transmission rate of the differential signal can be 100 Mbit/sec, 200 Mbit/sec or 400 Mbit/sec due to the multiple frequency. The 1394 controller and the 1394 physical layer can have a two-way communication via the data signal and a control signal is used to assign the type of communication between the 1394 controller and the 1394 physical layer. On the other hand, there are one-way signals such as the link request signal, the link power status signal, and the clock signal. The link request signal is sent from the 1394 controller to the 1394 physical layer, and is used to read/write the internal register of the 1394 physical layer. The link power status signal LPS is sent from the 1394 controller to the 1394 physical layer and is used to assign the power status of the 1394 controller. The frequency of the clock signal is 49.152 MHz, and the clock signal is sent from the 1394 physical layer to the 1394 controller and is for synchronizing the link request signal, the control signal and the data signal between the 1394 controller and the 1394 physical layer.

Furthermore, the 1394 controller comprises a system bus interface, a physical layer interface, and a clock and power managing device. The 1394 physical layer comprises a link interface, a phase lock loop and a transceiver. The system bus interface is connected to the system bus for transmitting the bus signal. The physical layer interface is connected to the link interface for transmitting the data signal, the control signal, and the link request signal. The clock and power managing device is connected to the phase lock loop for transmitting the clock signal and the link power status signal. The transceiver is connected to the electronic device for transmitting the differential signal. The functions of the individual signals are as mentioned above.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 illustrates a block diagram of a data processing system with a 1394 module according to a preferred embodiment of the invention;

FIG. 2A shows a block diagram of the 1394 module according to FIG. 1; and

FIG. 2B illustrates a detailed block diagram of the 1394 controller and the 1394 physical layer according to FIG. 2A.

### DESCRIPTION OF THE PREFERRED EMBODIMENT

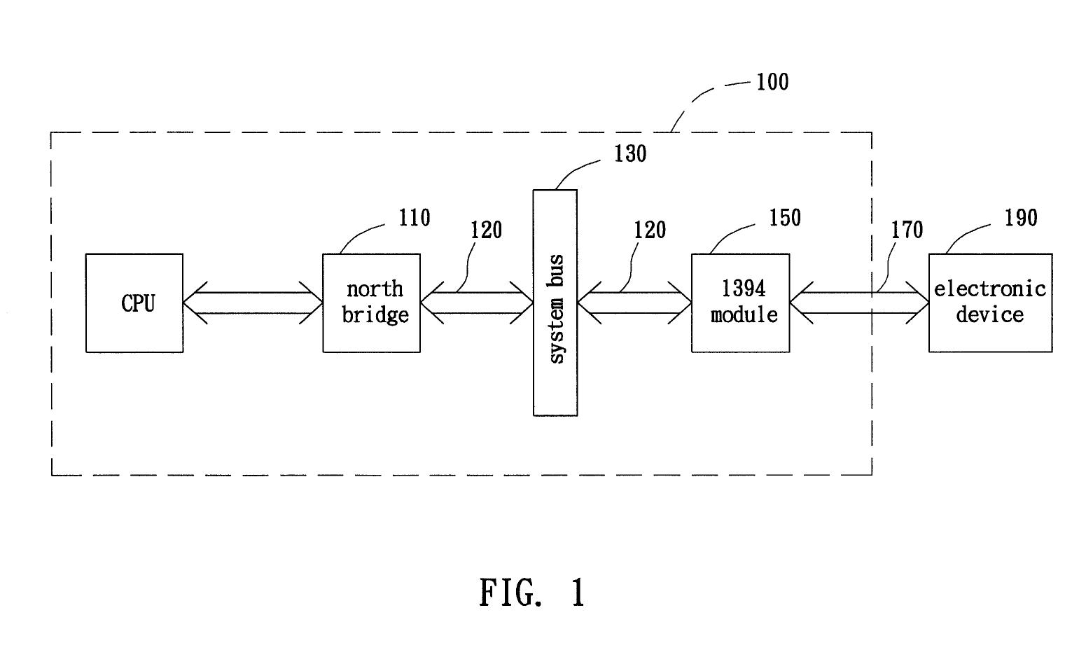

Referring to FIG. 1, a block diagram of a data processing system with a 1394 module according to a preferred embodiment of the invention is shown. The data processing system 100 comprises a CPU (Central Processing Unit), a north bridge 110, a south bridge (not shown), a system bus 130, and a 1394 module 150. In general, the system bus 130 is a Peripheral Component Interconnect (PCI) bus and a bus signal 120 is used for transmitting data between the system bus 130 and the north bridge 110. On the other hand, the bus signal 120 is also used for connecting the system bus 130 and the 1394 module 150. When the 1394 module 150 is connected to the electronic device 190, data is transmitted between the 1394 module 150 and the electronic device 190 via a differential signal 170 in packet.

The data processing system 100 mentioned above can be a personal computer or a notebook and the electronic device 190 can be a digital camera, a hard disk drive, a scanner, or a printer compatible to the 1394 module 150. The invention stated in FIG. 1 can be wildly applied into the daily life. For example, the user may take photos on his digital camera, and since the memory storage of a digital camera is limited, the user needs to transmit the image data (photos) from the digital camera to his hard disk in order to empty the memory storage space for the next time. The process of transmitting the image data is as follows: first, the image data is converted into a differential signal 170 and the differential signal 170 is transmitted into the 1394 module 150. Then the 1394 module 150 converts the differential signal 170 into a bus signal 120 and sends the bus signal 120 to the system bus 130. The CPU sends a read/write request to the hard disk drive via the chipset (it is the south bridge in this case), and after the bus signal 120 is converted, the bus signal 120 is sent to the hard disk drive.

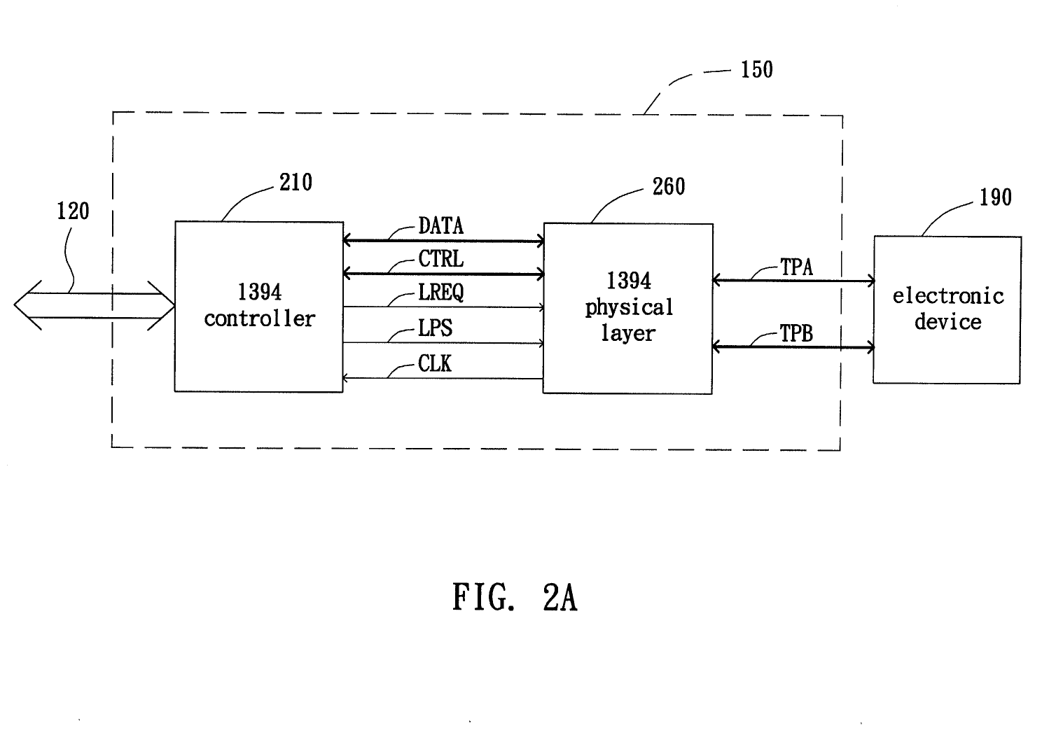

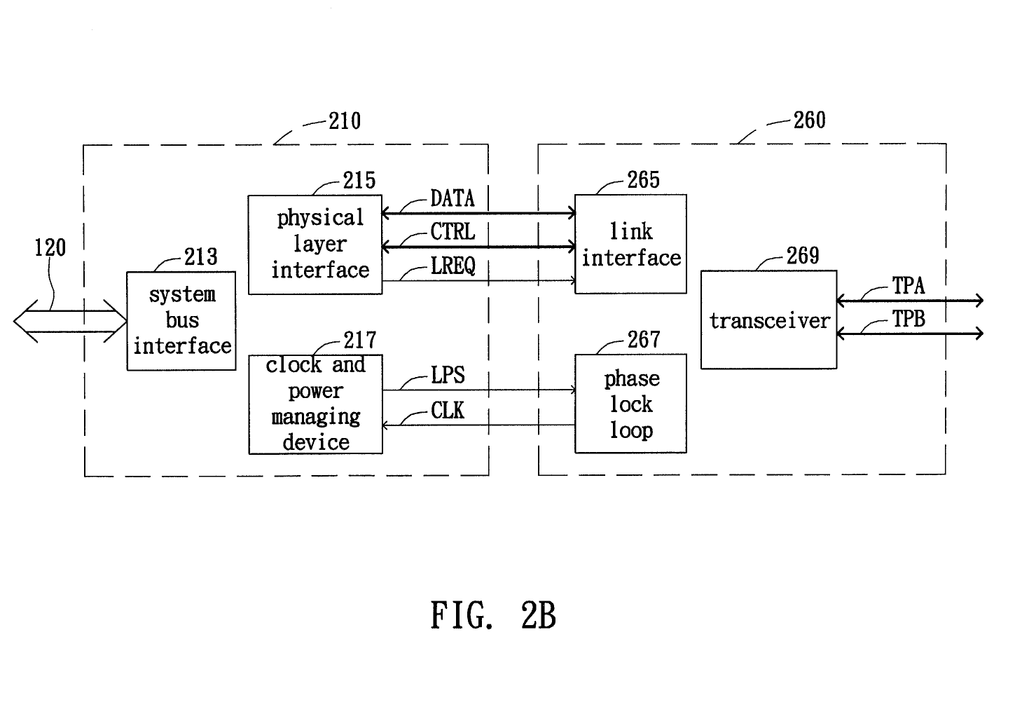

Referring to FIG. 2A, it illustrates a block diagram of the 1394 module 150. The 1394 module 150 comprises a 1394 controller 210 and a 1394 physical layer 260. The 1394 controller 210 is connected to the system bus 130 in order to transmit the bus signal 120, and the 1394 physical layer is connected to the electronic device 190 in order to transmit the differential signal 170. The differential signal 170 consists of a differential signal TPA and a differential signal TPB, and the differential signal TPA contains positive differential signal TPA+ and negative differential signal TPA−, the differential signal TPB contains positive differential signal TPB+ and negative differential signal TPB−. The transmission rate of the differential signal can be 100 Mbit/sec, 200 Mbit/sec or 400 Mbit/sec. The data signal DATA is a 8 bits two-way signal for sending data between the 1394 controller 210 and the 1394 physical layer 260. The width of the data signal DATA is decided by the transmission rate of the packet, for example, when the transmission rate is 100 Mbit/sec, bit 0 and bit 1 of the data signal DATA is used for transmitting the data. When the transmission rate is 200 Mbit/sec, bit 0 to bit 3 of the data signal DATA is used for transmitting the data. When the transmission rate is 400 Mbit/sec, the bit 0 to bit 7 of the data signal DATA is used for transmitting the data. The 1394 controller can be, but not limited to, Geode CS4103 of National Semiconductor, TSB41LV02 of Texas Instruments, etc.

The control signal CTRL is a 2 bits, two-way signal for assigning the type of communication such as idle, status, receive, and transmit between the 1394 controller 210 and the 1394 physical layer 260. The link request signal LREQ, the link power status signal LPS and the clock signal CLK are all single bit, one-way signal. The link request signal LREQ is sent from the 1394 controller 210 to the 1394 physical layer 260 for accessing the internal registers of the 1394 physical layer 260. The link power status signal LPS is sent from the 1394 controller 210 to the 1394 physical layer 260 for assigning the power status of the 1394 controller 210. When the link power status signal LPS is at logic 0, it indicates that the 1394 controller 210 is not powered so it disables the control signal CTRL, data signal DATA, and the clock signal CLK. The frequency of the clock signal CLK is 49.152 MHZ and is sent from the 1394 physical layer 260 to the 1394 controller 210. The clock signal CLK is for synchronizing the link request signal LREQ, the control signal CTRL, and the data signal DATA between the 1394 controller 210 and the 1394 physical layer 260.

Referring to FIG. 2B, it illustrates a detailed block diagram of the 1394 controller and the 1394 physical layer. The 1394 controller 210 comprises a system bus interface 213, a physical layer interface 215, and a clock and power managing device 217. The 1394 physical layer 260 comprises a link interface 265, a phase lock loop (PLL) 267 and a transceiver 269. The system bus interface 213 is connected to the system bus for transmitting the bus signal 120. The physical layer interface 215 is connected to the link interface 213 for transmitting the data signal DATA, the control signal CTRL, and the link request signal LREQ. The clock/power control device 217 is connected to the phase lock loop 267 for transmitting the clock signal CLK and link power status signal LPS. The transceiver 269 is connected to the electronic device for transmitting the differential signal TPA and the differential signal TPB. The functions of each signal are described in the paragraph above and will not be stated again.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A 1394 module which serves as a data transmission media between a system bus and an electronic device, comprising:
a 1394 controller, comprising:
a system bus interface connected to the system bus for transmitting a bus signal;
a physical layer interface for transmitting and receiving a data signal and a control signal, and transmitting a link request signal; and
a clock and power managing device for receiving a clock signal and transmitting a link power status signal; and
a 1394 physical layer, comprising:
a link interface connected to the physical layer interface for transmitting and receiving the data signal and the control signal and receiving the link request signal;
a phase lock loop connected to the clock and power managing device for transmitting the clock signal and receiving the link power status signal; and
a transceiver connected to the electronic device for transmitting a differential signal.

2. The 1394 module according to claim 1, wherein the system bus is a PCI bus.

3. The 1394 module according to claim 1, wherein the electronic device is a digital camera.

4. The 1394 module according to claim 1, wherein the electronic device is a hard disk drive.

5. The 1394 module according to claim 1, wherein the electronic device is a scanner.

6. The 1394 module according to claim 1, wherein the electronic device is a printer.

7. A data processing system with a 1394 module connected to an electronic device for processing data transmission between the data processing system and the electronic device, the data processing system comprising:
a system bus;
a north bridge connected to the system bus for transmitting the bus signal;
a physical layer interface for receiving and transmitting a data signal and a control signal and transmitting a link request signal; and
a clock and power managing device for receiving a clock signal and transmitting a link power status signal; and
a 1394 physical layer, comprising:
a link interface connected to the physical layer interface for receiving and transmitting the data signal and the control signal and receiving the link request signal;
a phase lock loop connected to the clock and power managing device for transmitting the clock signal and receiving the link power status signal; and
a transceiver connected to the electronic device for transmitting a differential signal.

8. The data processing system according to claim 7, wherein the data processing system is a personal computer.

9. The data processing system according to claim 7, wherein the data processing system is a notebook.

10. The data processing system according to claim 7, wherein the system bus is a PCI bus.

11. The data processing system according to claim 7, wherein the electronic device is a digital camera.

12. The data processing system according to claim 7, wherein the electronic device is a hard disk drive.

13. The data processing system according to claim 7, wherein the electronic device is a scanner.
